(19) United States
(12) Patent Application Publication
(10) Pub. No.: US 2017/0063589 A1
(43) Pub. Date: Mar. 2, 2017

(54) PACKET STRUCTURE FOR FREQUENCY OFFSET ESTIMATION AND METHOD FOR UL MU-MIMO COMMUNICATION IN HEW

(71) Applicant: Intel IP Corporation, Santa Clara, CA (US)

(72) Inventors: Xiaogang Chen, Beijing (CN); Qinghua Li, San Ramon, CA (US); Thomas J. Kenney, Portland, OR (US); Eldad Perahia, Portland, OR (US); Hujun Yin, Saratoga, CA (US)

(21) Appl. No.: 15/119,613

(22) PCT Filed: Apr. 29, 2014
(86) PCT No.: PCT/CN2014/076429

§ 371 Date: Aug. 17, 2016

(51) Int. Cl. H04L 27/26; H04L 5/00; H04B 7/04

(52) U.S. Cl. CPC H04L 27/2656; H04B 7/0452; H04L 5/0023; H04L 5/0007; H04W 84/12

(57) ABSTRACT

Embodiments of a packet structure for frequency offset estimation and method for UL MU-MIMO communication in high-efficiency Wi-Fi (HEW) are generally described herein. In some embodiments, the packet structure may comprise a short training field (STF), a number of long-training fields (LTFs) following the STF, a signal field (SIGB)to follow the LTFs, and a data field to follow the signal field. The data field may comprise an UL MU-MIMO transmission from a plurality of scheduled stations. The number of LTFs may be equal to or greater than a number of data streams as part of the UL MU-MIMO transmission, and the plurality of scheduled stations may share the number of LTFs by transmitting on different orthogonal tone sets.

### TECHNICAL FIELD

Embodiments pertain to wireless networks. Some embodiments relate to Wi-Fi networks and networks operating in accordance with one of the IEEE 802.11 standards. Some embodiments relate to high-efficiency wireless or high-efficiency Wi-Fi (HEW) communications including the IEEE 802.11ax draft standard. Some embodiments relate to uplink multi-user MIMO (UL MU-MIMO) communications.

### BACKGROUND

Wireless communications has been evolving toward ever increasing data rates (e.g., from IEEE 802.11a/g to IEEE 802.11n to IEEE 802.11ac). In high-density deployment situations, overall system efficiency may become more important than higher data rates. For example, in high-density hotspot and cellular offloading scenarios, many devices competing for the wireless medium may have low to moderate data rate requirements (with respect to the very high data rates of IEEE 802.11ac). The frame structure used for conventional and legacy IEEE 802.11 communications including very-high throughput (VHT) communications may be less suitable for such high-density deployment situations. Furthermore, this frame structure is unsuitable for UL MU-MIMO communications. The recently-formed study group for Wi-Fi evolution referred to as the IEEE 802.11 High Efficiency Wi-Fi (HEW) study group (SG) is addressing these high-density deployment scenarios.

Thus, there are general needs for devices and methods that improve overall system efficiency in wireless networks, particularly for high-density deployment situations. There are also general needs for devices and methods suitable for HEW communications. There are also general needs for devices and methods suitable for UL MU-MIMO communications in HEW.

### BRIEF DESCRIPTION OF THE DRAWINGS

FIG. 1 illustrates a High Efficiency Wi-Fi (HEW) network in accordance with some embodiments;

FIG. 2 illustrates a comparison of performance degradation due to frequency offset error between single-user (SU) and MU-MIMO communication;

FIGS. 3A and 3B illustrate frequency offset estimation in accordance with some embodiments;

FIGS. 4A, 4B, 4C, 4D and 4E illustrate packet structures for UL MU-MIMO communications in accordance with some embodiments;

FIG. 5 illustrates a procedure for UL MU-MIMO communication for HEW in accordance with some embodiments; and

FIG. 6 illustrates an HEW device in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Uplink (UL) multi-user (MU) multiple-input multiple output (MIMO) (UL MU-MIMO) is a promising approach being considered in 802.11ax (HEW) which could significantly improve Wi-Fi system throughput. Embodiments disclosed herein provide a new preamble structure which provides mechanisms affording client-specific frequency and channel estimation for UL MU-MIMO. In previous versions of the standard (IEEE 802.11a/n/ac), each uplink transmission was from one device only. In UL MU-MIMO, there are transmissions from multiple devices simultaneously. As such, the preamble in the previous versions is not sufficient to allow certain receiver parameters to be accurately estimated. Accordingly, various parts of the preamble may need to be modified to support UL MU-MIMO. The embodiments described herein here provide several novel approaches for a new preamble structure.

Conventionally, with an IEEE 802.11ac preamble structure, channels of different client devices (e.g., stations) are estimated using a single legacy very-high throughput (VHT) long-training field (LTF) (VHT-LTF) and these estimates are used to demodulate the data portion of the payload. The legacy short training field (L-STF) and the L-LTF are typically used for timing/frequency tracking, among other things, by the receiver. With UL-MU-MIMO, different clients may have different timing and frequency offsets relative to each other. Thus, using the conventional L-STF and L-LTF, the individual client impairments cannot easily be distinguished from each other. This results in performance degradation compared with single user (SU) communication. Embodiments disclosed herein provide, among other things, several techniques to help solve the issue of client-specific frequency offset correction.

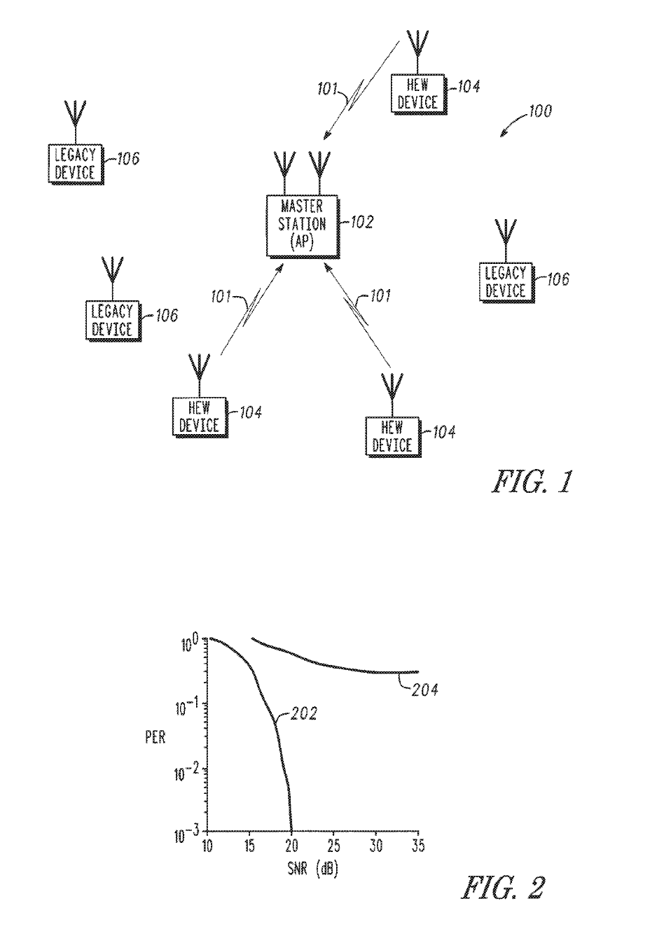

FIG. 1 illustrates a High Efficiency Wi-Fi (HEW) network in accordance with some embodiments. HEW network 100 may include a master station (STA) 102, a plurality of HEW stations 104 (i.e., HEW devices) and a plurality of legacy stations 106 (legacy devices). The master station 102 may be arranged to communicate with the HEW stations 104 and the legacy stations 106 in accordance with one or more of the IEEE 802.11 standards. In some embodiments, the master station 102 may be an access point (AP), although the scope of the embodiments is not limited in this respect.

In accordance with embodiments, the master station 102 may include physical layer (PHY) and medium-access control layer (MAC) circuitry which may be arranged to contend for a wireless medium (e.g., during a contention period) to receive exclusive control of the medium for an HEW control period (i.e., a transmission opportunity (TXOP)). The master station 102 may transmit an HEW master-sync transmission at the beginning of the HEW control period. During the HEW control period, the HEW stations 104 which are scheduled may communicate with the master station 102 in accordance with a non-contention based multiple access technique. This is unlike conventional Wi-Fi communications in which devices communicate in accordance with a contention-based communication technique, rather than a multiple access technique. During the HEW control period, legacy stations 106 refrain from communicating. In some embodiments, the master-sync transmission may be referred to as an HEW control and schedule transmission.

In accordance with embodiments, the master station 102 is arranged for communicating with a plurality of scheduled HEW stations 104 (e.g., client devices or user devices) in accordance with an UL MU-MIMO technique and may be configured to assign different tone sets to each of a plurality of scheduled stations 104 for use in transmission of a number of LTFs of a preamble of an uplink frame. The different tone sets may be orthogonal in the frequency domain for a particular LTF. The master station 102 may receive uplink signals 101 comprising the LTFs from the scheduled stations 104 followed by data transmitted in accordance with an UL-MU-MIMO technique. The master station 102 may also perform a frequency offset (FO) estimation for each individual station based on the uplink signals from either a same tone set received in two different of the LTFs or one of the LTFs and a signal field. The master station 102 may also perform a channel estimate for each individual station 104 based on the uplink signals received on different tone sets from across at least some of the LTFs. The scheduled stations 104 may be considered client devices and may be HEW stations, although the scope of the embodiments is not limited in this respect.

In these embodiments, by sharing an OFDM symbol (i.e., an LTF), the frequency offsets of individual stations 104 as well as the channel estimates of individual stations 104 may be estimated during the preamble of an HEW frame. In some of these embodiments, different tone sets may be allocated to different clients in each LTF and an additional LTF may be added to assist the frequency offset correction. In some other embodiments, different tone sets may be allocated to different clients in each LTF and the frequency offset estimation/enhanced channel estimation may be left up to the receiver's implementation. These embodiments are described in more detail below.

In some embodiments, a packet structure for UL MU-MIMO communications is provided. The packet structure may comprise a short training field (STF), a number of LTFs following the STF, a signal field to follow the LTFs, and a data field to follow the signal field. The data field may comprise an UL MU-MIMO transmission from a plurality of scheduled stations 104. The number of LTFs may be equal to or greater than a number of data streams to be received by a master station 102 as part of the UL MU-MIMO transmission. The plurality of scheduled stations 104 may be arranged share the number of LTFs by transmitting on different orthogonal tone sets. In these embodiments, the master station 102 may be arranged to receive and process this packet structure in accordance with a UL MU-MIMO technique. A scheduled station 104 may be arranged to configure a packet in accordance with this packet structure for transmission in accordance with a UL MU-MIMO technique. These embodiments are discussed in more detail below.

FIG. 2 illustrates a comparison of performance degradation due to frequency offset error between single-user (SU) communication 202 and MU-MIMO communication 204. As can be seen, MU-MIMO communications 204 are more susceptible to performance degradation. The embodiments disclosed herein help reduce the performance degradation in UL MU-MIMO communications. Embodiments disclosed herein furthermore provide several new preamble structures suitable for use in HEW including in IEEE 802.11ax.

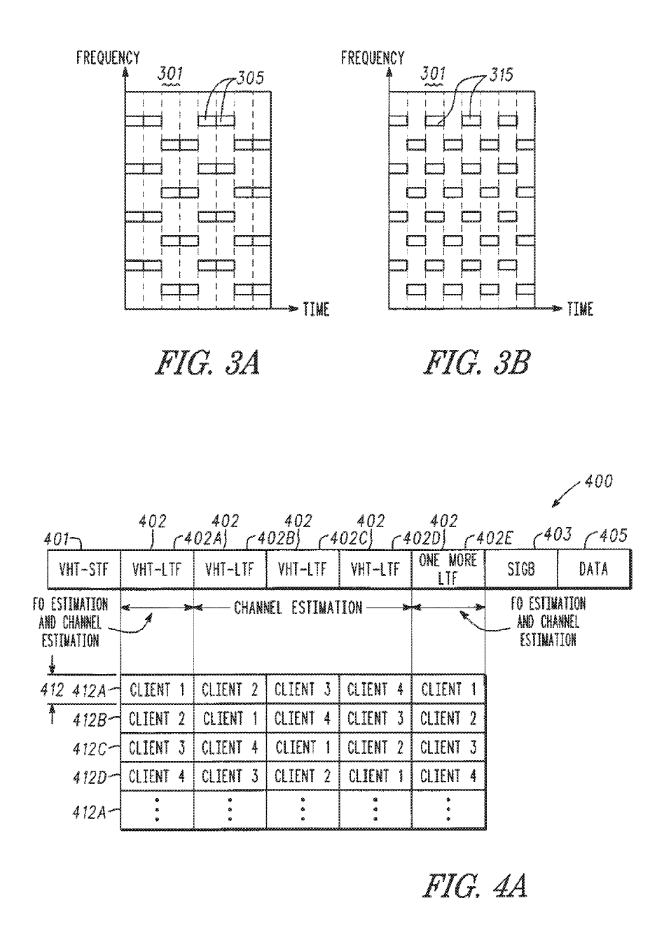

FIGS. 3A and 3B illustrate frequency offset estimation in accordance with some embodiments. The principle of frequency offset estimation is to let each client transmit a signal on the set of subcarriers across the preamble. Then, by checking the phase difference across different symbols in the preamble, the receiver can estimate the frequency offset. In FIGS. 3A and 3B, pilot signals transmitted on the same subcarriers but at different times may be used to estimate the frequency offset. In FIG. 3A, pilot signals in adjacent OFDM symbols 305 are used. In FIG. 3B, pilot signals in non-adjacent OFDM symbols 315 may be used. In FIGS. 3A and 3B, the OFDM symbols have a symbol duration 311.

Besides this technique, embodiments disclosed herein provide other alternatives as an extension for frequency offset correction. For example, in some embodiments, different tone sets are allocated to different clients in each LTF and one more LTF may be added to assist the frequency offset correction. In some other embodiments, different tone sets are assigned for different clients in each LTF and the frequency offset estimation/enhanced channel estimation may be left up to the particular receiver implementation.

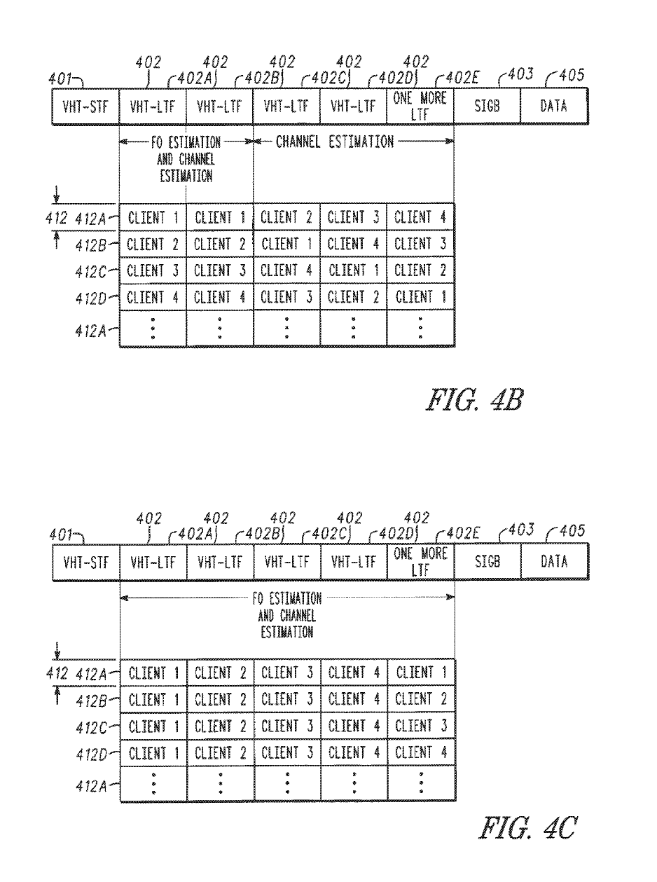

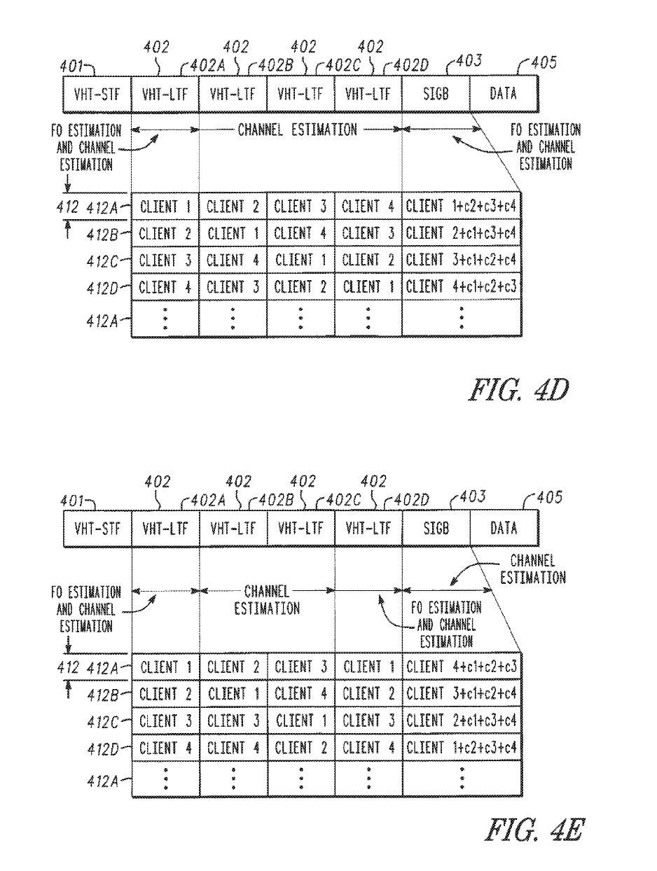

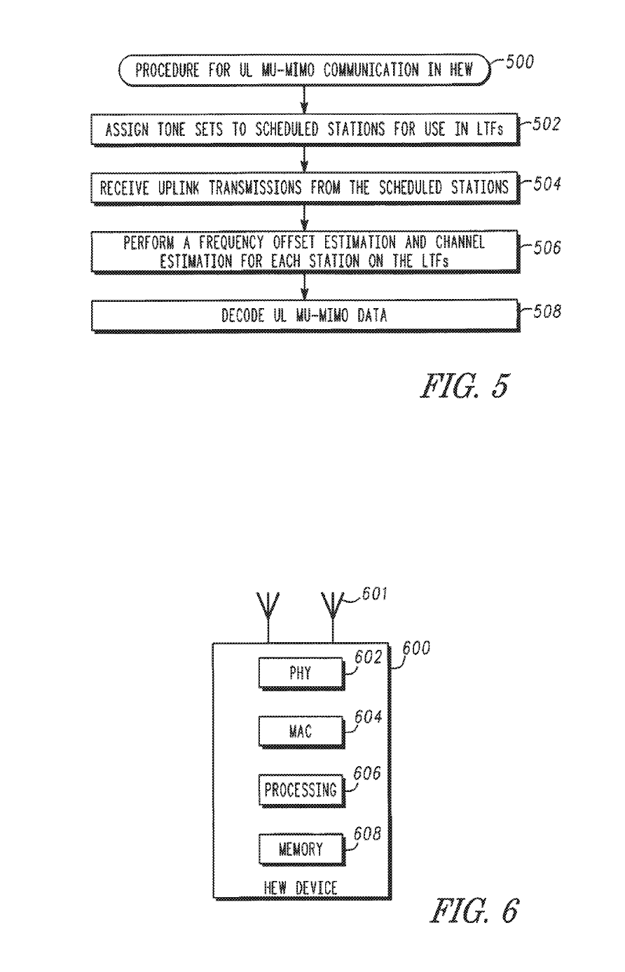

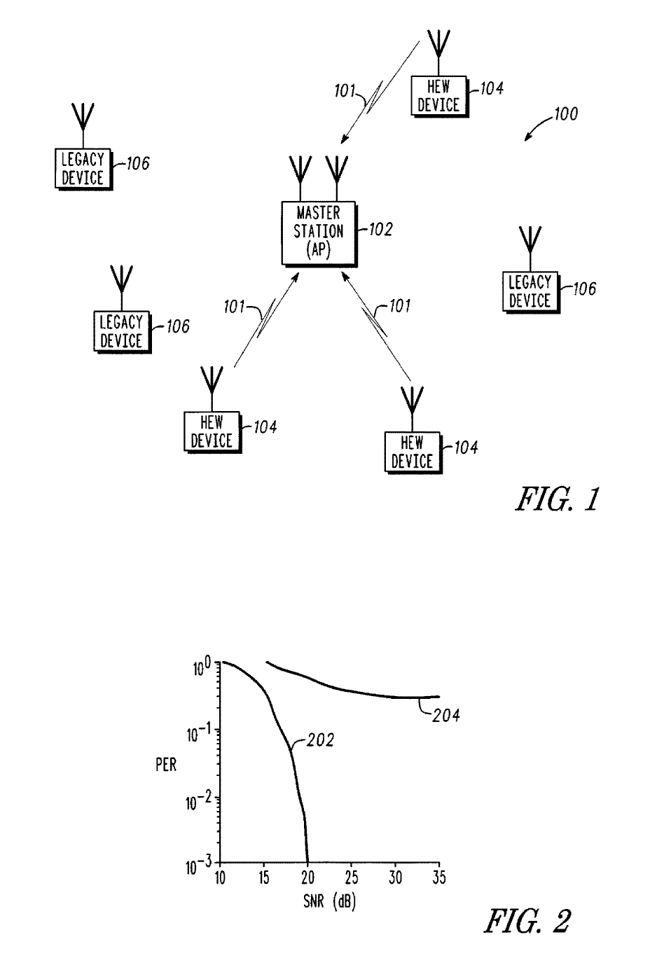

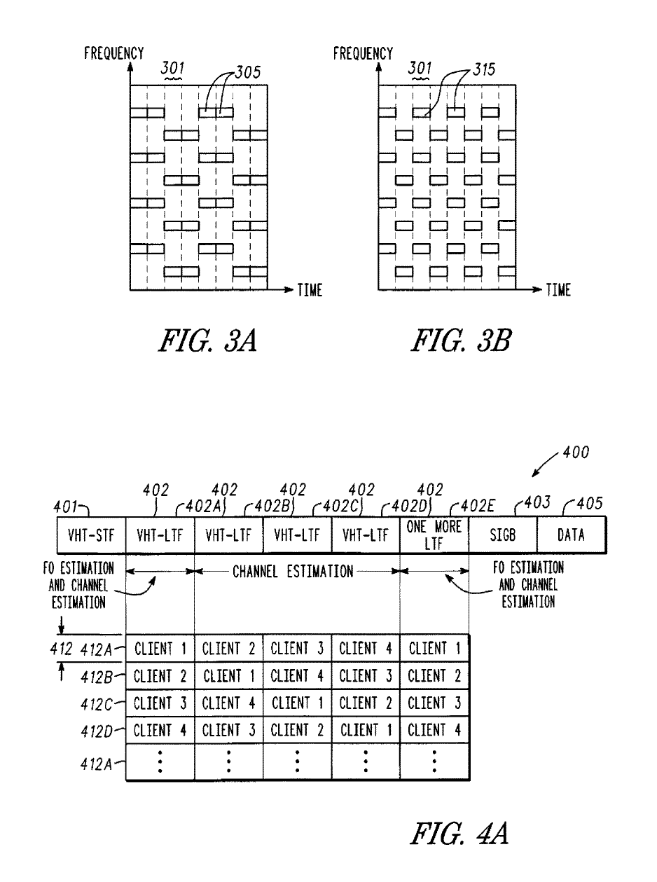

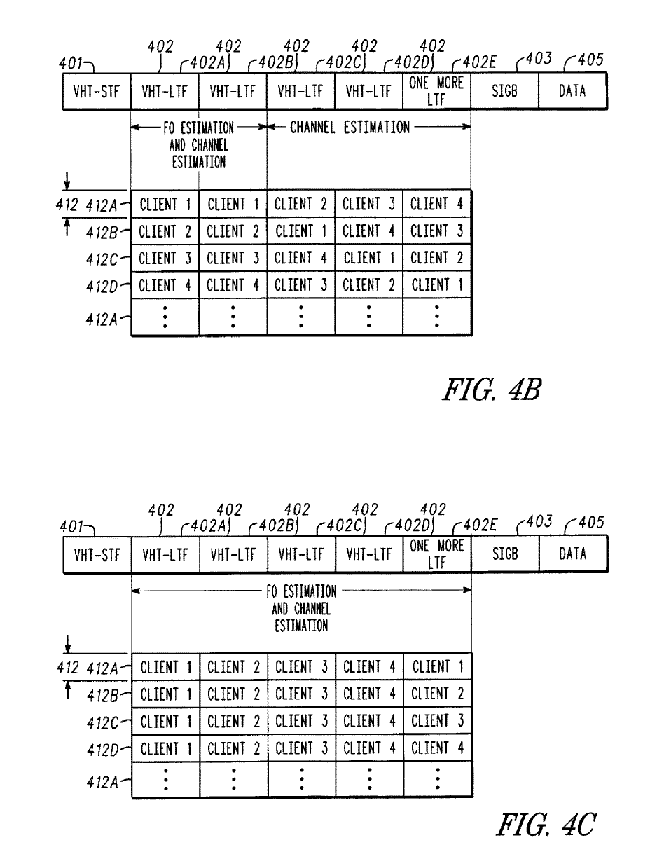

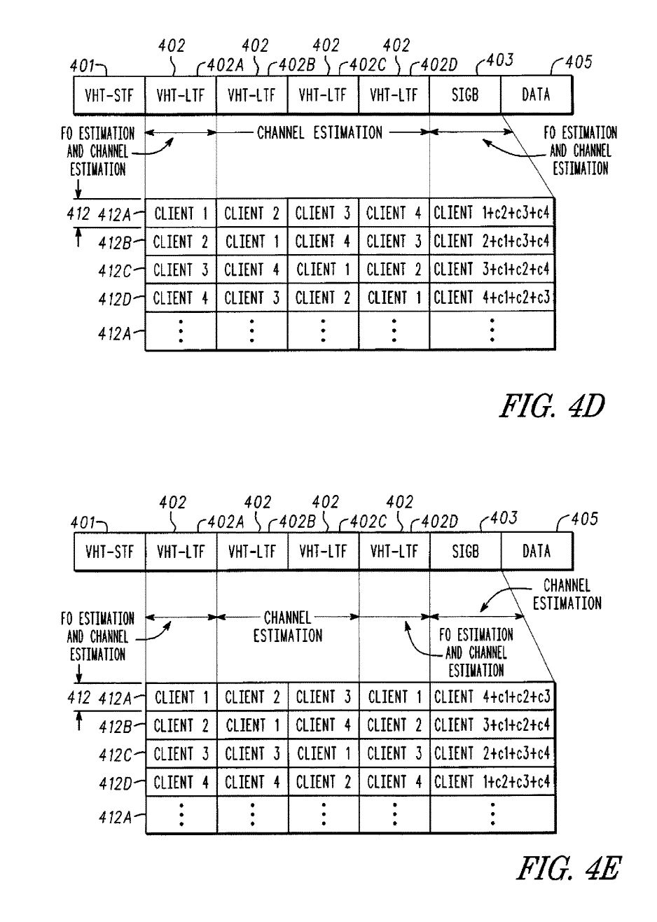

FIGS. 4A, 4B, 4C, 4D and 4E illustrate packet structures for UL MU-MIMO communications in accordance with some embodiments. The packet structures illustrated in FIGS. 4A, 4B, 4C, 4D and 4E may be considered HEW frames or packets. In accordance with embodiments, the packet structure may comprise a short training field (STF) 401, a number of long-training fields (LTFs) 402 following the STF 401, a signal field (SIGB) 403 to follow the LTFs 402, and a data field 405 to follow the signal field 403. The preamble may refer to fields before the data field.

The data field 405 may comprise an UL MU-MIMO transmission from a plurality of scheduled stations 104. The number of LTFs 402 may be equal to or greater than a number of data streams to be received by a master station 102 as part of the UL MU-MIMO transmission. The plurality of scheduled stations 104 may be arranged to share the number of LTFs 402 by transmitting on different orthogonal tone sets. In these embodiments, the master station 102 may be arranged to receive and process this packet structure in accordance with a UL MU-MIMO technique. A scheduled station 104 may be arranged to configure a packet in accordance with one of the packet structures for transmission in accordance with a UL MU-MIMO technique. These packet structures may allow the master station 102 to perform a frequency offset estimate and channel estimate for receipt of UL MU-MIMO transmissions and reduce and possibly eliminate the performance degradation illustrated in FIG. 2.

In accordance with some embodiments, the master station 102 may be configured to assign different tone sets 412 to each of a plurality of stations 104 (e.g., HEW STAs) for use in transmission of a number of LTFs 402 of a preamble of an uplink frame. The different tone sets may be orthogonal in the frequency domain for a particular LTF. The master station 102 may also be arranged to receive uplink signals 101 comprising the LTFs 402 from the scheduled stations 104 followed by data transmitted in accordance with a UL-MU-MIMO technique. The master station 102 may also be arranged to perform a frequency offset estimation for each individual station based on the uplink signals from either a same tone set received in two different of the LTFs 402 or one of the LTFs and the signal field 403. The master station 102 may also be arranged to perform a channel estimate for each individual station 104 based on the uplink signals received on different tone sets from across at least some of the LTFs 402. These embodiments are described in more detail below.

In these embodiments, by sharing an OFDM symbol (i.e., an LTF), the frequency offsets of individual stations 104 as well as the channel estimates of individual stations 104 may be estimated during the preamble of an HEW frame. In some of these embodiments, different tone sets may be allocated to different clients in each LTF 402 and an additional LTF may be added to assist the frequency offset correction. In some other embodiments, different tone sets may be allocated to different clients in each LTF 402 and the frequency offset estimation/enhanced channel estimation may be left up to the receiver's implementation. These embodiments are described in more detail below.

In the example embodiments illustrated in FIG. 4A, each client (corresponding with a scheduled station 104) may transmit uplink signals on different orthogonal tone sets 412 during each LTF 402. Furthermore, each client may transmit uplink signals on the same tone set in at least two different of the LTFs. For example, client 1 may transmit on the same tone set 412A during the first LTF 402A and the fifth LTF 402E, client 2 may transmit on the same tone set 412B during the first LTF 402A and the fifth LTF 402E, client 3 may transmit on the same tone set 412C during the first LTF 402A and the fifth LTF 402E, and client 4 may transmit on the same tone set 412D during the first LTF 402A and the fifth LTF 402E. Tone sets 412A, 412B, 412C and 412D may be orthogonal in the frequency domain.

In this example, the master station 102 may perform a frequency offset estimate for client 1 based on the signals received on the tone set 412A from client 1 during the first LTF 402A and the fifth LTF 402E, the master station 102 may perform a frequency offset estimate for client 2 based on the signals received on the tone set 412B from client 2 during the first LTF 402A and the fifth LTF 402E, the master station 102 may perform a frequency offset estimate for client 3 based on the signals received on the tone set 412C from client 3 during the first LTF 402A and the fifth LTF 402E, the master station 102 may perform a frequency offset estimate for client 4 based on the signals received on the tone set 412C from client 3 during the first LTF 402A and the fifth LTF 402E, and the master station 102 may perform a frequency offset estimate for client 4 based on the signals received on the tone set 412D from client 4 during the first LTF 402A and the fifth LTF 402E.

In this example, the master station 102 may perform a channel estimation for each client device based on the uplink signals received from a client device on tone sets 412A, 412A, 412B, 412C and 412D in the various LTFs. For example, the master station 102 may perform a channel estimation for client device 1 based on the signals received from client device 1 on tone set 412A during the first LTF 4021, tone set 412B during the second LTF 402B, on tone set 412C during third LTF 402C, on tone set 412D during forth LTF 402D, and/or tone set 412A during fifth LTF 402E.

In the example embodiments illustrated in FIG. 4A with four client devices and four streams, the tone set assigned to client 1 for the first LTF 402A may comprise every 4^{th} tone starting with the first tone (i.e., tone 1, tone 5, tone 9, etc.), the tone set assigned to client 2 for LTF 402A may comprise every 4^{th} tone starting with the second tone (i.e., tone 2, tone 6, tone 10, etc.).

In some embodiments, the scheduled stations 104 may be high-efficiency Wi-Fi (HEW) stations and the master station 102 may be a HEW access point, although the scope of the embodiments is not limited in this respect. In some embodiments, the HEW stations and HEW access point may be arranged to communicate in accordance with an IEEE 802.11 standard, such as the IEEE 802.11ax draft standard, although the scope of the embodiments is not limited in this respect.

In some embodiments, each LTF 402 may comprise a long-training sequence. The uplink signals may be received from the scheduled stations 104 without a legacy preamble. The STF 401 may comprise a short-training sequence (shorter than the long training sequence) preceding the LTFs 402, the signal field 403 may follow the LTFs 402 and the data field 405 may comprise data from the scheduled stations 104 transmitted in accordance with the UL MU-MIMO technique. The master station 102 may use the frequency offset estimate and channel estimate to demodulate the data in the data field 405 from each scheduled station 104.

In these embodiments, no legacy preamble is needed since the master station 102 may have contended for the medium, obtained a transmission opportunity, and may have scheduled an UL MU-MIMO exchange. Thus the transmissions by the scheduled stations 104 may have sufficient protection and neighboring devices (e.g., legacy devices 106 and HEW stations 104 that are not scheduled) may be adequately deferred.

In accordance with some embodiments, the number of LTFs 402 to be included in the preamble of the uplink frame may be based at least on a number of uplink streams and the number of LTFs to be included in the preamble of the HEW frame may be increased to assist the frequency offset correction. In the example embodiments illustrated in FIGS. 4A-4E, at least four LTFs 402 may be included in uplink frame for channel estimation since four uplink streams are to be received by the master station 102 (i.e., one from each scheduled station). Embodiments disclosed herein are suitable for up to eight or more streams. In the example embodiments illustrated in FIGS. 4A-C, an additional LTF 402 (i.e., for a total of five LTFs) may be included to assist in frequency offset estimation and correction. In these embodiments, the number of LTFs 402 to be included in the preamble of the uplink frame is one more than the number of streams.

In some embodiments, the tone sets 412 may be assigned so that each scheduled station 104 is arranged to transmit on the same tone set during at least two of the LTFs 402 of the preamble and the master station 102 may be arranged to perform a frequency offset estimation for each individual station 104 using the uplink transmissions received from said individual station on the same tone set during two of the LTFs 402.

In the example embodiments illustrated in FIG. 4A, the signals received on the same tone set in LTF 402A and 402E may be used by the master station 102 for frequency offset correction for each client device. In FIG. 4A, tone repetition (i.e., use of identical sets of tones) is provided in the first LTF 402A and the fifth LTF 402E for each client device.

In the example embodiments illustrated in FIG. 4B, the signals received on the same tone set are received in adjacent LTFs (i.e., LTF 402A and 402B) and may be used by the master station 102 for frequency offset correction. These embodiments may provide for a higher resolution of the frequency error. In FIG. 4B, the tone repetition is provided, for example, in the first and second LTFs (rather than in the first and fifth LTFs), which may be used for auto-correlation for use in reducing or eliminating the impact of multipath in timing-boundary acquisition.

In the example embodiments illustrated in FIG. 4C, each scheduled station may be assigned different tone sets in one of the LTFs (e.g.,

LTF 402E) and each scheduled station 104 may be exclusively assigned to one of the other LTFs. In these embodiments, one LTF (e.g., LTF 402E) of the uplink frame may be shared while the other LTFs (LTFs 402A-402D) may be exclusively to a scheduled station 104. In the example embodiments illustrated in FIG. 4C, client device 1 may be assigned exclusively to the first LTF 402A (i.e., transmit on all tones) and may be assigned tone set 412A of fifth LTF 402E, client device 2 may be assigned exclusively to the second LTF 402B (i.e., transmit on all tones) and may be assigned tone set 412B of fifth LTF 402E, client device 3 may be assigned exclusively to the third LTF 402C (i.e., transmit on all tones) and may be assigned tone set 412C of fifth LTF 402E, and client device 4 may be assigned exclusively to the fourth LTF 402D (i.e., transmit on all tones) and may be assigned tone set 412D of fifth LTF 402E. In these embodiments, the master station 102 may be able to perform a more accurate timing correction using the exclusively assigned LTFs for a single client device.

In the example embodiments illustrated in FIG. 4C, the signals received on the same tone set from client 1 in first LTF 402A and fifth LTF 402E may be used for frequency offset estimation, the signals received on the same tone set from client 2 in second LTF 402B and fifth LTF 402E may be used for frequency offset estimation, the signals received on the same tone set from client 3 in third LTF 402C and fifth LTF 402E may be used for frequency offset estimation, and the signals received on the same tone set from client 4 in the fourth LTF 402D and fifth LTF 402E may be used for frequency offset estimation.

In some embodiments (e.g., illustrated in FIGS. 4A-4C), the number of LTFs 402 is at least one more than the number of data streams and each scheduled station 104 is arranged to transmit on a same tone set within at least two of the LTFs 402. In these embodiments, the master station 102 may perform frequency offset estimation for each scheduled station based on LTF transmissions in the same tone set. In these embodiments, the master station 102 may perform a channel estimation for each scheduled station using the transmissions of a number of the LTFs that equal the number of data streams.

In the example embodiments illustrated in FIG. 4A, each scheduled station 104 may be arranged to transmit on the same tone set in a first and a last LTF (e.g., LTF 402A and 402E). In these embodiments, the master station 102 may perform a frequency offset estimation for each scheduled station based on the same tone set in a first and a last LTF.

In the example embodiments illustrated in FIG. 4B each scheduled station 104 may be arranged to transmit on the same tone set in adjacent LTFs (e.g., LTFs 402A and 402B). In these embodiments, the master station 102 may perform a frequency offset estimation for each scheduled station based on the same tone set in the adjacent LTFs.

In the example embodiments illustrated in FIG. 4C, each scheduled station 104 is arranged to transmit on different tone sets within only one of the LTFs (e.g., LTF 402E), and within the other LTFs (e.g., LTFs 402A-D) each scheduled station is arranged to transmit on all tone sets of an assigned LTF.

In some embodiments, the tone sets in different LTFs for the same clients may be shifted in frequency to cover as many tones as possible. In FIG. 4A, the tone sets for each of the client devices are identical in the 1^{st} LTF and the last LTF, on which frequency offset can be estimated. In FIG. 4B, tone repetition comes from the 1st and 2nd LTFs instead of 1st and last LTFs 402. Comparing this with FIG. 4A, a potential benefit of this alternative may be afforded from the repetition on the 1st and 2nd LTF which could be used for auto correlation which is useful to eliminate the impact of multipath in timing boundary acquisition. In FIG. 4C, unlike the embodiments of FIGS. 4A and 4B, different LTFs are assigned exclusively to different clients for channel estimation and the last LTF 402 may be used for frequency offset correction. One benefit of the technique of FIG. 4C is that each LTF can be used for timing correction for the corresponding client with higher accuracy compared with FIGS. 4A and 4B due to the exclusive LTF allocation to each client.

In the example embodiments illustrated in FIGS. 4D and 4E, the number of LTFs 402 is equal to the number of data streams (i.e., no additional LTF is included, such as LTF 402E of FIGS. 4A-4C). In these embodiments, during the signal field 403, each scheduled station may be arranged to transmit on different tone sets corresponding to the tone sets of one of the LTFs (i.e., LTF 402A). The tone sets of the signal field 403 may be frequency interleaved. In the embodiments illustrated in FIG. 4D, the master station 102 may perform a frequency offset estimation for each scheduled station based on the tone sets received from a station in the signal field 403 and one of the LTFs. In the embodiments illustrated in FIG. 4E, the master station 102 may perform a frequency offset estimation for each scheduled station based on the tone sets received from a station in based on LTF transmissions in the same tone set (e.g., LTF 402A and 402D) and the signal field 403 may be used for channel estimation.

In the embodiments illustrated in FIGS. 4D and 4E, the signal field 403 may be tone-interleaved with respect to each of the scheduled stations 104, and the master station 102 may be arranged to perform the channel estimation and/or the frequency offset estimation for each of the scheduled stations 104 using the signal field 403 and one or more of the LTFs 402.

In the embodiments illustrated in FIG. 4D, an additional LTF (such as LTF 402E of FIGS. 4A, 4B and 4C)) is not needed so the preamble of the frame may include one less OFDM symbol. In these embodiments, the frequency offset correction technique may be left up to the receiver implementation. For example, the receiver may first decode the signal field 403 and estimate the channel based on the signal field 403 based on a successive interference cancellation (SIC) technique. Then the signal field 403 may be reprocessed for frequency offset estimation. Alternatively, the receiver may estimate the channel for each client by interpolation and frequency offset correction may be done without the assistance of the signal field 403.

In the embodiments illustrated in FIG. 4E, client devices may transmit on the same tone set in the first LTF 402A and the final (i.e., fourth LTF 402D) LTF, and the master station 102 may determine the frequency offset for each scheduled station 104 based on the first and final LTFs. In these embodiments, the signal field 403 may be used to enhance the channel estimate. In the embodiments illustrated in FIG. 4E, the first and final LTFs may be replicated and used by the master station for the frequency offset estimation.

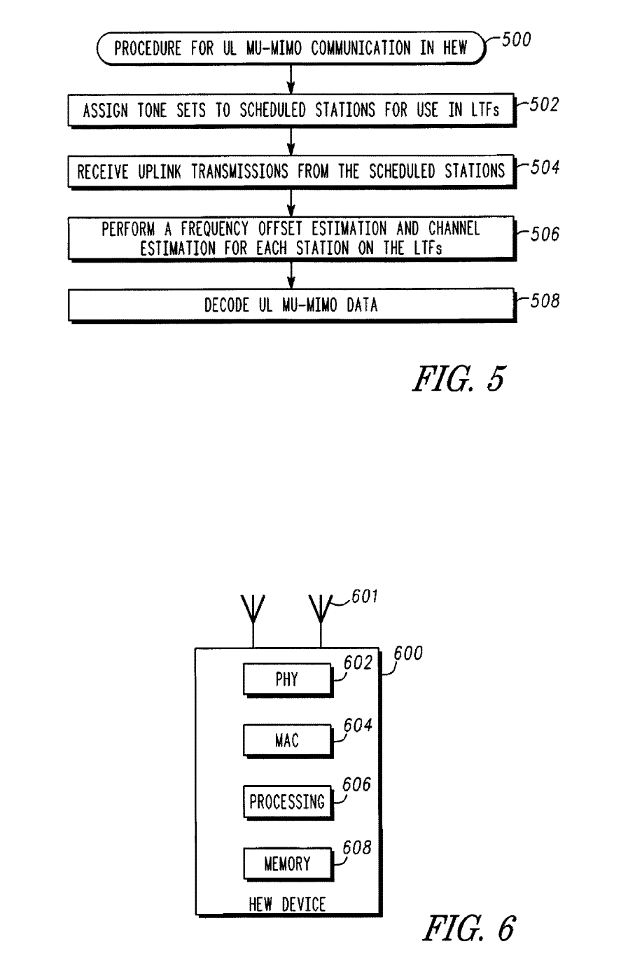

FIG. 5 illustrates a procedure for UL MU-MIMO communication for HEW in accordance with some embodiments. Procedure 500 may be performed by a master station, such as master station 102 (FIG. 1). In accordance with embodiments, the UL MU-MIMO transmissions discussed above may be received from the scheduled stations 104 during a control period and the master station 102 may be arranged to contend for a wireless medium during a contention period to receive control of the medium for the control period. During the control period, the master station 102 may have exclusive use of the wireless medium for communication with the scheduled stations 104 in accordance with a non-contention based multiple-access technique. The non-contention based multiple-access technique may be a scheduled OFDMA technique. The master station 102 may transmit a master-sync/control transmission at the beginning of the control period to provide synchronization and scheduling information to the scheduled stations 104 including assignment of tone sets within the LTFs to the scheduled stations 104 (i.e., operation 502).

In operation 504, the master station 102 may receive uplink signals 101 comprising the LTFs 402 from the scheduled stations 104 followed by data transmitted in accordance with a UL-MU-MIMO technique.

In operation 506, the master station 102 may perform a frequency offset estimation for each individual station based on the uplink signals from either a same tone set received in two different of the LTFs 402 or one of the LTFs and a signal field 403. In operation 506, the master station 102 may also perform a channel estimate for each individual station 104 based on the uplink signals received on different tone sets from across at least some of the LTFs 402.

In operation 508, the master station 102 may decode and/or demodulate the data in the data field 405 from each scheduled station 104 using the frequency offset estimation and channel estimation for each scheduled station 104.

In accordance with some HEW embodiments, an access point may operate as a master station which may be arranged to contend for a wireless medium (e.g., during a contention period) to receive exclusive control of the medium for an HEW control period (i.e., a transmission opportunity). The master station may transmit an HEW master-sync transmission at the beginning of the HEW control period. During the HEW control period, scheduled HEW stations may communicate with the master station in accordance with a non-contention based multiple access technique. This is unlike conventional Wi-Fi communications in which devices communicate in accordance with a contention-based communication technique, rather than a multiple access technique. During the HEW control period, the master station may communicate with scheduled HEW stations using one or more HEW frames. During the HEW control period, legacy stations (and non-scheduled HEW stations) refrain from communicating. In some embodiments, the master-sync transmission may be referred to as an HEW control and schedule transmission. In accordance with some embodiments, minimum bandwidth OFDMA units may be used for communication with HEW stations during the HEW control period.

In some embodiments, the multiple-access technique used during the HEW control period may be a scheduled orthogonal frequency division multiple access (OFDMA) technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique.

The master station may also communicate with legacy stations in accordance with legacy IEEE 802.11 communication techniques. In some embodiments, the master station may also be configurable communicate with HEW stations outside the HEW control period in accordance with legacy IEEE 802.11 communication techniques, although this is not a requirement.

In some embodiments, data fields 405 of an HEW frame may be configurable to have the same bandwidth and the bandwidth may be one of 20 MHz, 40 MHz, or 80 MHz contiguous bandwidths or an 80+80 MHz (160 MHz) non-contiguous bandwidth. In some embodiments, a 320 MHz contiguous bandwidth may be used. In some embodiments, bandwidths of 5 MHz and/or 10 MHz may also be used. In these embodiments, each data field 405 of an HEW frame may be configured for transmitting a number of spatial streams.

FIG. 6 illustrates an HEW device in accordance with some embodiments. HEW device 600 may be an HEW compliant device and may be suitable for use as a master station 102 and/or a station 104. HEW device 600 may be arranged to communicate with one or more other HEW devices, as well as communicate with legacy devices. HEW device 600 may be suitable for operating as a master station 102 or an HEW station, such as stations 104. In accordance with embodiments, HEW device 600 may include, among other things, physical layer (PHY) circuitry 602 and medium-access control layer circuitry (MAC) 604. PHY 602 and MAC 604 may be HEW compliant layers (e.g., IEEE 802.11ax compliant) and may also be compliant with one or more legacy IEEE 802.11 standards. PHY 602 may be arranged to transmit and receive HEW frames including UL MU-MIMO frames configured in accordance with the packet structure illustrated in FIGS. 4A-4E. HEW device 600 may also include other processing circuitry 606 and memory 608 configured to perform the various operations described herein.

In accordance with some embodiments, when operating as a master station 102, the MAC 604 may be arranged to contend for a wireless medium during a contention period to receive control of the medium for the HEW control period and configure an HEW frame. The PHY 602 may be arranged to transmit the HEW frame as discussed above. The PHY 602 may also be arranged to receive an HEW frame from HEW stations. When operating as a scheduled station, HEW device 600 may be configured to transmit UL MU-MIMO transmissions using the packet structure illustrated in one or more of FIGS. 4A-4E. MAC 604 may also be arranged to perform transmitting and receiving operations through the PHY 602. The PHY 602 may include circuitry for modulation/demodulation, upconversion/downconversion, filtering, amplification, etc. In some embodiments, the processing circuitry 606 may include one or more processors. In some embodiments, two or more antennas may be coupled to the physical layer circuitry arranged for sending and receiving signals including transmission of the HEW frame in accordance with an UL MU-MIMO technique. The memory 608 may be store information for configuring the processing circuitry 606 to perform operations for configuring and transmitting HEW frames and performing the various operations described herein. In some embodiments, a master station may include a receiver including a frequency offset estimator to estimate a frequency offset for each scheduled station.

In some embodiments, the HEW device 600 may be configured to communicate using OFDM communication signals over a multicarrier communication channel. In some embodiments, HEW device 600 may be configured to receive signals in accordance with specific communication standards, such as the Institute of Electrical and Electronics Engineers (IEEE) standards including IEEE 802.11-2012, 802.11n-2009 and/or 802.11ac-2013 standards and/or proposed specifications for WLANs including proposed HEW standards (e.g., IEEE 802.11ax), although the scope of the invention is not limited in this respect as they may also be suitable to transmit and/or receive communications in accordance with other techniques and standards. In some other embodiments, HEW device 600 may be configured to receive signals that were transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, HEW device 600 may be part of a portable wireless communication device, such as a personal digital assistant (PDA), a laptop or portable computer with wireless communication capability, a web tablet, a wireless telephone or smartphone, a wireless headset, a pager, an instant messaging device, a digital camera, an access point, a television, a medical device (e.g., a heart rate monitor, a blood pressure monitor, etc.), or other device that may receive and/or transmit information wirelessly. In some embodiments, HEW device 600 may include one or more of a keyboard, a display, a non-volatile memory port, multiple antennas, a graphics processor, an application processor, speakers, and other mobile device elements. The display may be an LCD screen including a touch screen.

The antennas 601 of HEW device 600 may comprise one or more directional or omnidirectional antennas, including, for example, dipole antennas, monopole antennas, patch antennas, loop antennas, microstrip antennas or other types of antennas suitable for transmission of RF signals. In some MIMO embodiments, the antennas 601 may be effectively separated to take advantage of spatial diversity and the different channel characteristics that may result between each of antennas and the antennas of a transmitting station.

Although HEW device 600 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of HEW device 600 may refer to one or more processes operating on one or more processing elements.

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. Some embodiments may include one or more processors and may be configured with instructions stored on a computer-readable storage device.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A master station arranged to communicate in accordance with an uplink (UL) multi-user (MU) multiple-input multiple-output (MIMO) (UL MU-MIMO) technique, the master station configured to:
assign different tone sets to each of a plurality of scheduled stations for transmission of a number of long-training fields (LTFs) an uplink frame, wherein the different tone sets are orthogonal in the frequency domain;
receive uplink signals comprising the LTFs from the scheduled stations followed by data transmitted in accordance with an UL-MU-MIMO technique; and
perform a frequency offset (FO) estimation for each individual scheduled station based on the uplink signals from either a same tone set received in two different of the LTFs or one of the LTFs and a signal field.

2. The master station of claim 1 wherein each LTF comprises a long-training sequence,
wherein the uplink signals are received from the scheduled stations without a legacy preamble, and
wherein the uplink signals further comprise:
a short training field (STF) comprising a short training sequence preceding the LTFs;
the signal field following the LTFs; and
a data field comprising the data from the schedule stations transmitted in accordance with the UL MU-MIMO technique, and
wherein the master station is further configured to use the frequency offset estimate and a channel estimate to demodulate the data in the data field from each scheduled station, and
wherein the master station is arranged to determine the channel estimate for each individual station based on the uplink signals received on different tone sets from across at least some of the LTFs.

3. The master station of claim 2 wherein the number of LTFs to be included in a preamble of the uplink frame is based at least on a number of uplink streams and includes an additional LTF for use in the frequency offset estimation.

4. The master station of claim 2 wherein the tone sets are assigned so that each scheduled station is arranged to transmit on the same tone set during at least two of the LTFs of the preamble, and
wherein the master station is arranged to perform the frequency offset estimation for each individual station using the uplink transmissions received from an individual station on the same tone set during two of the LTFs.

5. The master station of claim 2 wherein each scheduled station is assigned different tone sets in one of the LTFs and each scheduled station is exclusively assigned to one of the other LTFs.

6. The master station of claim 2 wherein the signal field is tone-interleaved with respect to each of the scheduled stations, and
wherein the master station is arranged to perform the channel estimation and/or the frequency offset estimation for each of the scheduled stations using the signal field and one or more of the LTFs.

7. The master station of claim 2 wherein the first and final LTFs are replicated and used by the master station for the frequency offset estimation.

8. The master station of claim 2 wherein the UL MU-MIMO transmissions are received from the scheduled stations during a control period,
wherein the master station is further arranged to:
contend for a wireless medium during a contention period to receive control of the medium for the control period, wherein during the control period, the master station has exclusive use of the wireless medium for communication with the scheduled stations in accordance with a non-contention based multiple-access technique;
transmit a master-sync/control transmission at the beginning of the control period to provide synchronization and scheduling information to the scheduled stations including assignment of tone sets within the LTFs to the scheduled stations; and
demodulate the data in the data field from each scheduled station using the frequency offset estimation and channel estimation for each scheduled station in accordance with a UL MU-MIMO technique.

9. The master station of claim 8 wherein the non-contention based multiple-access technique is a scheduled orthogonal frequency division multiple access (OFDMA) technique.

10. A packet structure for uplink (UL) multi-user (MU) multiple-input multiple-output (MIMO) (UL MU-MIMO) communications, the packet structure comprising:
a short training field (STF);
a number of long-training fields (LTFs) following the STF;
a signal field (SIGB) to follow the LTFs; and
a data field to follow the signal field, the data field comprising an UL MU-MIMO transmission from a plurality of scheduled stations,
wherein the number of LTFs is equal to or greater than a number of data streams that are part of the UL MU-MIMO transmission, and
wherein the plurality of scheduled stations share the number of LTFs by transmitting on different orthogonal tone sets.

11. The packet structure of claim 10 wherein the number of LTFs is at least one more than the number of data streams, and
wherein each scheduled station is arranged to transmit on a same tone set within at least two of the LTFs.

12. The packet structure of claim 11 wherein each scheduled station is arranged to transmit on the same tone set in a first and a last LTF.

13. The packet structure of claim 11 wherein each scheduled station is arranged to transmit on the same tone set in adjacent LTFs.

14. The packet structure of claim 11 wherein each scheduled station is arranged to transmit on different tone sets within only one of the LTFs, and
wherein within the other LTFs each scheduled station is arranged to transmit on all tone sets of an assigned LTF.

15. The packet structure of claim 10 wherein the number of LTFs is equal to the number of data streams, and
wherein during the signal field, each scheduled station is arranged to transmit on different tone sets corresponding to the tone sets of one of the LTFs.

16. A station (STA) arranged for scheduled communication with a master station in accordance with an uplink (UL) multi-user (MU) multiple-input multiple-output (MIMO) (UL MU-MIMO) technique, the scheduled station configured to:
receive an assignment of different tone sets for use in transmission of a number of long-training fields (LTFs) an uplink frame;
transmit the LTFs using the assigned tone sets concurrently with the LTFs of other scheduled stations; and
transmit data following the LTFs concurrently with the other scheduled stations in accordance with the UL MU-MIMO technique,
wherein the tone sets of the LTFs are shared by the scheduled stations to allow the master station to perform channel estimation and frequency offset estimation.

17. The station of claim 16 wherein each LTF comprises a long-training sequence, and
wherein station is configured to transmit the uplink signals without a legacy preamble, and
wherein the uplink signals further comprise:
a short training field (STF) comprising a short training sequence preceding the LTFs;
the signal field following the LTFs; and
a data field comprising the data from the scheduled station and one or more other scheduled stations transmitted in accordance with the UL MU-MIMO technique.

18. The station of claim 17 wherein the number of LTFs to be included in a preamble of the uplink frame is based at least on a number of uplink streams and includes an additional LTF for use in the frequency offset estimation.

19. The station of claim 17 wherein the tone sets are assigned so that each scheduled station is arranged to transmit on the same tone set during at least two of the LTFs of the preamble.

20. A non-transitory computer-readable storage medium that stores instructions for execution by one or more processors of a master station for communication in accordance with an uplink (UL) multi-user (MU) multiple-input multiple-output (MIMO) (UL MU-MIMO) technique, the operations to configure the master station to:
assign different tone sets to each of a plurality of scheduled stations for transmission of a number of long-training fields (LTFs) an uplink frame, wherein the different tone sets are orthogonal in the frequency domain;
receive uplink signals comprising the LTFs from the scheduled stations followed by data transmitted in accordance with an UL-MU-MIMO technique; and
perform a frequency offset (FO) estimation for each individual scheduled station based on the uplink signals from either a same tone set received in two different of the LTFs or one of the LTFs and a signal field.

21. The non-transitory computer-readable storage medium of claim 20 wherein each LTF comprises a long-training sequence,
wherein the uplink signals are received from the scheduled stations without a legacy preamble, and
wherein the uplink signals further comprise:
a short training field (STF) comprising a short training sequence preceding the LTFs;
the signal field following the LTFs; and
a data field comprising the data from the scheduled stations transmitted in accordance with the UL MU-MIMO technique, and
wherein the master station is further configured to use the frequency offset estimate and a channel estimate to demodulate the data in the data field from each scheduled station, and
wherein the master station is arranged to determine the channel estimate for each individual station based on the uplink signals received on different tone sets from across at least some of the LTFs.

22. The non-transitory computer-readable storage medium of claim 21 wherein the number of LTFs to be included in a preamble of the uplink frame is based at least on a number of uplink streams and includes an additional LTF for use in the frequency offset estimation.

23. The non-transitory computer-readable storage medium of claim 21 wherein the tone sets are assigned so that each scheduled station is arranged to transmit on the same tone set during at least two of the LTFs of the preamble, and
wherein the master station is arranged to perform the frequency offset estimation for each individual station using the uplink transmissions received from an individual station on the same tone set during two of the LTFs.
